(19) United States
(12) Patent Application Publication
(10) Pub. No.: US 2025/0027911 A1
(43) Pub. Date: Jan. 23, 2025

(54) DEVICE FOR MOBILE PHASE VELOCITY CONTROL ACROSS THE DIAMETER OF A CHROMATOGRAPHY COLUMN

(71) Applicant: Waters Technologies Corporation, Milford, MA (US)

(72) Inventors: Wade P. Leveille, Douglas, MA (US); Fabrice Gritti, Franklin, MA (US); Jason F. Hill, Upton, MA (US); Sornanathan Meyyappan, Framingham, MA (US); Joseph D. Michienzi, Plainville, MA (US)

(21) Appl. No.: 18/777,771

(22) Filed: Jul. 19, 2024

Related U.S. Application Data
(60) Provisional application No. 63/528,297, filed on Jul. 21, 2023.

(51) Int. Cl. G01N 30/60; G01N 30/02

(52) U.S. Cl. CPC G01N 30/603; G01N 30/6017; G01N 2030/027

(57) ABSTRACT

A frit and a chromatography column that includes the frit are described. The frit is formed as a disk having a porosity, a radius and a thickness. The disk has a variation in porosity, thickness, or both porosity and thickness along a radial direction. A flow of a liquid through an outer region of the disk is advanced at an outlet end of the disk relative to a flow of the liquid through an inner region of the disk. The frit is configured to be disposed at one end of a column bed of a liquid chromatography column where the advance in the flow in the outer region relative to the flow in the inner region is predetermined to at least partially compensate for a radial variation in the linear velocity of the flow through the column bed.

### RELATED APPLICATION

This application claims priority to U.S. Provisional Patent Application No. 63/528,297 filed on Jul. 21, 2023 and titled “Device for Mobile Phase Velocity Control Across the Diameter of a Chromatography Column, the entirety of which is incorporated by reference herein.

### FIELD OF THE INVENTION

The disclosed technology generally relates to chromatography columns. More particularly, the technology relates to a device to control the flow of liquid through a chromatography column to achieve improved chromatographic peak resolution.

### BACKGROUND

In typical chromatographic columns, a mobile phase and injected sample are introduced to a column separation bed through a fluidic conduit coupled to an end nut at the column inlet. The mobile phase then flows through some form of distributor coupled to a frit so that the mobile phase is distributed substantially uniformly over the inlet surface of the column separation bed.

Particulate chromatography columns for high performance liquid chromatography (HPLC) and ultra-performance liquid chromatography (UPLC) are typically packed with particles having a particle size in a range of about 1.6 μm to 5.0 μm. The particles are packed under high pressure, for example, from about 70 MPa (10,000 psi) to about 200 MPa (30,000 psi) using conventional slurry packing protocols. During the particle bed consolidation, a higher stress occurs in particles located near the stainless steel wall (e.g., within a region approximately 150 μm from the wall) relative to the stress that occurs for particles in the center bulk region of the column.

The wall-to-center stress profile due to packing results in a wall-to-center bed heterogeneity defined by local interparticle void fraction. Consequently, the linear chromatographic velocity for the region of particles near the wall is less than for the region near the center of the column. This radial variation in linear chromatographic velocity (i.e., the “wall effect”) distorts the chromatographic band. As a result, a detected chromatographic band corresponding to an analyte in the injected sample may exhibit peak tailing where the peak width is broader than otherwise expected. Thus, the resolution power is degraded. This effect is particularly problematic for certain applications such as Monoclonal Antibodies (mAb) applications.

### SUMMARY

In one aspect, a frit for a chromatography column includes a disk having a porosity, a radius and a thickness. The disk has at least one of a variation in the porosity in a radial direction and a variation in the thickness in the radial direction. A flow of a liquid received at an inlet end of the disk is advanced at an outlet end of the disk in an outer region of the disk relative to the flow of the liquid in an inner region of the disk in response to the at least one of the variation in the porosity in the radial direction and the variation in the thickness in the radial direction. The frit is configured to be disposed at one end of a column bed of a liquid chromatography column. The advance in the flow of the liquid in the outer region relative to the flow of the liquid in the inner region is predetermined to at least partially compensate for a radial variation in the linear velocity of the flow of the liquid through the column bed.

The thickness in the outer region may be greater than the thickness in the inner region. The disk may include a central cross-section having a thickness and at least one annular cross-section having a thickness that is greater than the thickness of the central cross-section. The disk may include a plurality of annular cross-sections each having a different thickness.

The variation in the thickness in the radial direction may be a continuous variation in the thickness. The variation in the porosity in the radial direction may be a continuous variation in the porosity.

The porosity in the outer region may be greater than the porosity in the inner region. The disk may include a central circular cross-section having a porosity and at least one annular cross-section having a porosity that is greater than the porosity of the central circular cross-section. There may be a plurality of annular cross-sections each having a different porosity.

In another aspect, a device for controlling flow across a diameter of a chromatography column includes an end nut and a frit. The end nut is configured for attachment to an inlet end or an outlet end of a column bed. The frit is disposed in the end nut and includes a disk having a porosity, a radius and a thickness. The disk has at least one of a variation in the porosity along the radius and a variation in the thickness along the radius. A flow of a liquid received at an inlet end of the disk is advanced at an outlet end of the disk in an outer region relative to a flow of the liquid in an inner region by a predetermined distance in response to the at least one of the variation in the porosity along the radius and the variation in the thickness along the radius. The advance in the flow of the liquid in the outer region relative to the flow of the liquid in the inner region is predetermined to at least partially compensate for a radial variation in the linear velocity of the flow of the liquid through the column bed.

The end nut may be an inlet end nut having an inlet to receive the flow of liquid and the device may further include a distributor disposed between the inlet end nut and the frit. The distributor may include a conical opening formed in the inlet end nut to distribute the flow received at an inlet port of the inlet end nut into a substantially uniform flow across an inlet face of the frit. The distributor may include a flat plate having at least one opening shaped to distribute the flow received at an inlet port of the inlet end nut into a substantially uniform flow across the inlet face of the frit.

The end nut may be an outlet end nut having an outlet to provide the flow of liquid and the device may further include a collector disposed between the outlet end nut and the frit. The collector may include a conical opening formed in the outlet end nut to collect the flow from the column bed and provide the flow through the outlet. The collector may include a flat plate having at least one opening shaped to substantially uniformly collect the flow from the column bed and provide the flow through the outlet.

In another aspect, a chromatography column includes a column wall, a column bed, an inlet end nut, an outlet end nut, a first frit and a second frit. The column bed includes a stationary phase material disposed inside the column wall and further includes an inlet end and an outlet end. The inlet end nut and the outlet end nut are secured at the inlet end and the outlet end, respectively, of the column bed. The first frit is disposed between the inlet end of the column bed and the inlet end nut and the second frit is disposed between the outlet end of the column bed and the outlet end nut. At least one of the first and second frits includes a disk having a porosity, a radius and a thickness. The disk has at least one of a variation in the porosity in the radial direction and a variation in the thickness in the radial direction. A flow of a liquid received at an inlet end of the disk is advanced at an outlet end of the disk in an outer region of the disk relative to the flow of the liquid in an inner region of the disk in response to one or both of the variation in the porosity in the radial direction and the variation in the thickness in the radial direction.

The advance in the flow of the liquid in the outer region relative to the flow of the liquid in the inner region may be predetermined to at least partially compensate for a radial variation in the flow of the liquid through the column bed.

The inlet end nut may include an inlet port to receive the flow of the liquid and a distributor to provide the received flow of the liquid through the first frit to the inlet end of the column bed. The outlet end nut may include a collector to receive the flow of the liquid from the outlet end of the column bed after passing through the second frit and an outlet port to provide the received flow of the liquid.

The column wall may be coated with one or more of stainless steel, titanium, polyether ether ketone and glass.

The first and second frits may be outside the column wall or may be immobilized inside the column wall at the inlet and outlet ends of the column bed, respectively.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is a schematic depiction of an example of how linear chromatographic velocity varies across the diameter of a chromatography column.

FIG. 2 a graphical representation of how a chromatographic peak for an analyte propagating through a chromatography column is affected by a variation in linear chromatographic velocity with radius.

FIG. 3 shows a chromatogram for an example of a separation by size exclusion chromatography run.

FIG. 4 is a cross-sectional side view illustration of an example of an inlet end of a chromatographic column.

FIG. 5 is a cross-sectional side view illustration of an inlet end portion of an example of a chromatography column in accordance with one embodiment.

FIG. 6A is a side view illustration of the frit shown in FIG. 5.

FIG. 6B is an end end view illustration of the frit shown in FIG. 5.

FIG. 7 graphically depicts an example of how a chromatographic peak corresponding to flow through a central region of the chromatography column of FIG. 5 overlaps in time with a chromatographic peak corresponding to flow through an outer region of the chromatography column.

FIG. 8 is a cross-sectional side view illustration of an inlet end portion of an example of a chromatographic column in accordance with another embodiment.

FIG. 9A is a side view illustration of the frit shown in FIG. 8.

FIG. 9B is an end view illustration of the frit shown in FIG. 8.

FIG. 10 is a cross-sectional side view illustration of an inlet end portion of an example of a chromatographic column in accordance with another embodiment.

FIG. 11 is a side view illustration of the frit shown in FIG. 10.

FIG. 12 is a cross-sectional side view illustration of an outlet end portion of an example of a chromatographic column in accordance with another embodiment.

FIG. 13 is a simplified cross-sectional view of an example of an end nut.

FIG. 14 is a simplified cross-sectional view of an end nut used as an alternative to the end nut of FIG. 13.

FIG. 15 shows an example of a distributor plate that may be used with the end nut of FIG. 14.

FIG. 16 is a cross-sectional side view illustration of an inlet end portion of an example of a chromatography column in accordance with another embodiment.

FIG. 17A shows a detailed exploded view of one example of the end nut shown in FIG. 16.

FIG. 17B show a cross-sectional side view of the end nut of FIG. 17A.

FIG. 18 is a cross-sectional side view illustration of an inlet end portion of an example of a chromatography column in accordance with another embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments and examples disclosed herein are directed to a frit having a radially-dependent property that imparts a radial variation in the flow of liquid passing linearly through the thickness of the frit. In one implementation, the property is a radially varying thickness while, in another implementation, the property is a radially varying porosity. Chromatographic columns equipped with devices having frits in accordance with these features can be used to perform various types of liquid chromatography including HPLC and UPLC.

As used herein, a device for controlling the flow through a chromatography column means a component assembly that can be attached at an end of a chromatography column. For example, the device may include an end nut that is secured at either end of a chromatography tube. The device further includes one or more elements such as a frit comprised of a porous material and/or a distributor plate. The device effectively controls the flow velocity across the column entrance diameter or the column exit diameter.

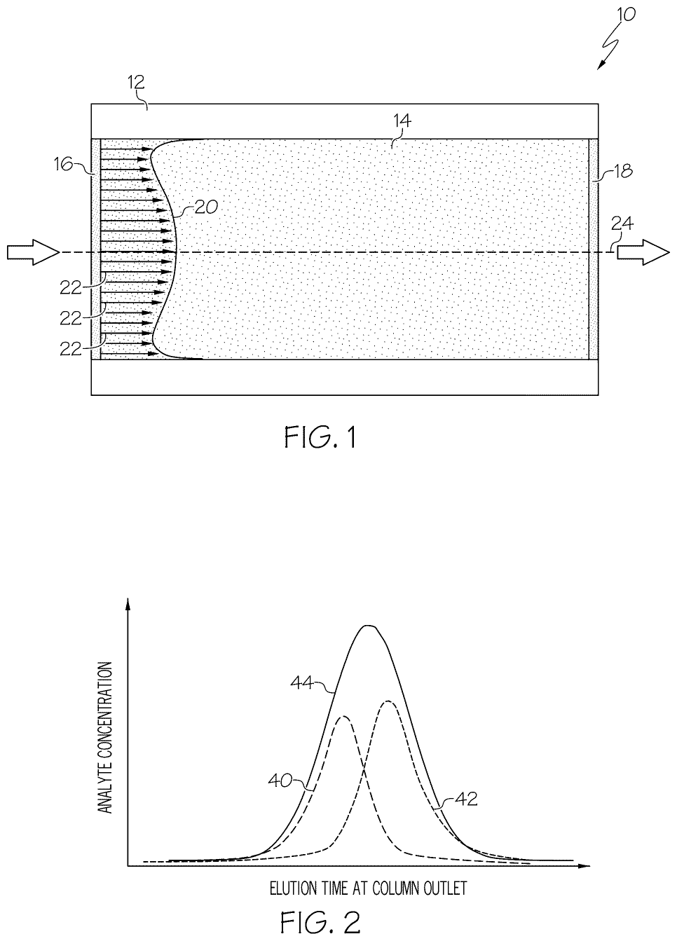

As described above, the wall-to-center bed heterogeneity for a liquid chromatography column due to particle bed packing typically leads to a variation in linear chromatographic velocity across the column radius and results in chromatographic distortion. This variation in velocity distorts the chromatographic band and degrades column performance and resolution power. FIG. 1 is a schematic representation of how the linear chromatographic velocity varies across the diameter of a column 10. The two large arrows along the column axis indicate the flow direction. The column 10 includes a stainless steel tube 12 having a packed particle bed 14 with a frit 16 at the inlet end and another frit 18 at the outlet end. Curve 20 imposed on the illustration is a graphical depiction of an example of a velocity profile 20 across the diameter of the column 10. The velocity profile 20 indicates the magnitude of individual linear velocity vectors along the diameter where each velocity vector indicates the linear velocity in a direction parallel to the column axis 24. The greatest velocity is along the column axis 24 and the velocity decreases with increasing radial distance from the column axis 24. Although there is a region near the inner surface of the tube 12 where the velocity increases due to large void spacing where the spherical particles are tangent to the inner surface, this region exits only over a small radial distance (e.g., 2 μm to 10 μm, according to particle size) and is insignificant with respect to the full cross-sectional area of the column 10.

Introduction of a plug of analyte at the inlet (frit 16) of the column bed 14 corresponds to the analyte being received at the same time across the full cross-section of the inlet. Ignoring the small radial distance adjacent to the tube inner surface described above, the plug of analyte begins to propagate through the packed particle bed 14 such that analyte along the column axis 24 travels through the column 10 fastest with analyte linear velocity decreasing with increasing radial distance from the axis 24 according to the radially varying velocity profile 20. The velocity profile 20 in FIG. 1 is exaggerated to illustrate this effect.

Long columns can be particularly problematic because the analyte at greater radial distances from the axis 24 (i.e., in the “outer region”) remains in its region for a significant time and increasingly lags behind analyte distributed closer to and along the axis 24 of the column (i.e., in the “central region”) during the full migration along the length of the column 10.

FIG. 2 is a graphical representation of how a chromatographic peak for an analyte propagating through a chromatography column is affected by the variation in linear velocity with radius. Plot 40 is a chromatographic peak for a portion of the analyte on and near to the column axis and plot 42 is a chromatographic peak for the same analyte in an annular region of greater radial distance from the column axis out to near the column wall. The analyte nearest the axis elutes from the column at an earlier time than the analyte in the outer region. The resulting analyte peak 44, which is effectively the combination of the two peaks 40 and 42, exhibits significant broadening with respect the peak widths of the individual peaks 40 and 42.

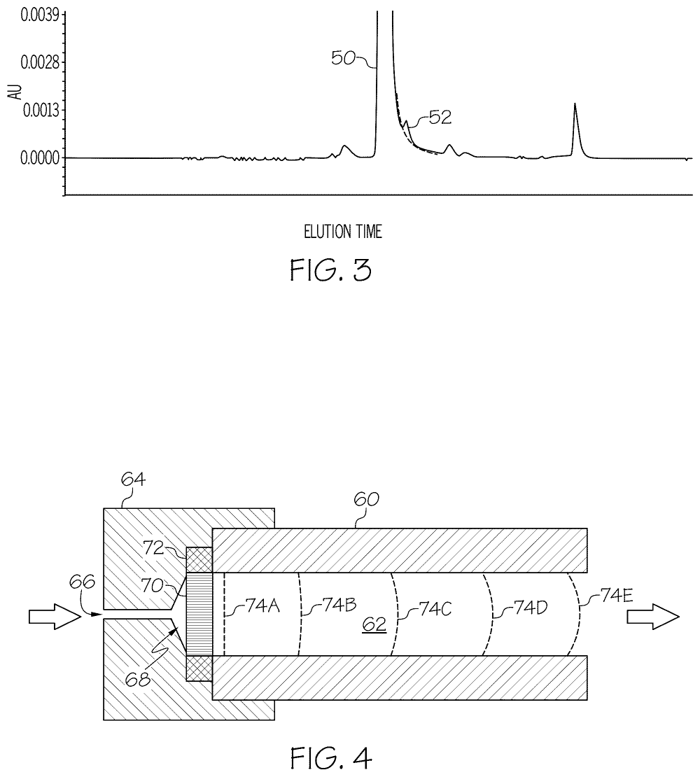

The problem of radial velocity variation can be critical for slow diffusive analytes. FIG. 3 is a chromatogram for one example of a separation by size exclusion chromatography run. The separation utilized a 2.1 mm×30 cm BEH200 SEC column from Waters Corporation of Milford, MA. The chromatogram includes a chromatographic peak 50 for a monoclonal antibody having a 150 kDa mass and a 97% abundance. Also shown is a chromatographic peak 52 for an impurity in the form of a non-reduced monoclonal antibody subunit having a 121 kDa mass and a 3% abundance. The upper portion of the larger chromatographic peak 50 is not shown so as to enable observation of the smaller impurity chromatographic peak 52. The presence of the impurity is nearly masked due to the high abundance of the monoclonal antibody relative to the abundance of the subunit in combination with the poor chromatographic resolution resulting from the radial velocity variation across the column. Thus, a means of reducing the radial variation in linear velocity is desirable for improving the chromatographic resolution.

FIG. 4 is a cross-sectional side view illustration of the inlet end of a chromatographic column. The column includes a column bed 62 comprised of a stationary phase material disposed inside the inner surface of a column wall 60. The column wall 60 is an open tube and may be formed of one or more of stainless steel, polyether ether ketone (PEEK), titanium, glass and the like which optionally may be coated on the inner surface.

An inlet end nut 64 is secured to the column wall 60 at the inlet end of the column bed 62. Similarly, an outlet end nut (not shown) is secured to the column wall 60 at the opposite (outlet) end of the column bed 62. The inlet end nut 64 includes an inlet port 66 to receive the flow of mobile phase and injected sample and further includes a distributor 68 to expand the received flow into a substantially uniform flow across the inlet face of the frit 70. As illustrated, the distributor 68 is a conical opening having a full cone angle of approximately 170° although, in alternative embodiments, the full cone angle may be different, or a different form of distributor may be used. A frit 70 in the form of a flat disk is disposed at the wide end of the distributor 68 and the inlet end of the column bed 62 with a gasket 72 or O-ring.

It should be understood that the outlet end nut may be similar in structure to the inlet end nut 64 and is arranged in a mirror image configuration at the outlet end of the column bed 62. Thus, the conical opening in the outlet end nut functions as a collector to receive the mobile phase flow from the outlet end of the column bed 62 and provides the flow through an outlet port. For example, the flow from the outlet port may be conducted to a detector, a fraction collector and/or other modules accessing the eluent having the separated components of the chromatographic run.

During a chromatographic separation, a flow of mobile phase (and any injected sample) is received at the inlet port 66 and expanded such that the flow at the inlet face of the frit 70 is substantially constant regardless of inlet face location. The flow passes through the thickness of the frit 70 and through the column bed 62 before being collected at the column end nut. The dashed lines 74A to 74E (generally 74) in the figure indicate how the flow is changed by the wall effect as it propagates through the column. Downstream from the frit 70 just inside the inlet end of the column bed 62, the flat dashed line 74A indicates how the flow near the column axis and the flow near the column wall have progressed nearly the same distance in the axial direction. The velocity variation across the column bed diameter results in the flow at the center increasingly “outrunning” the flow near the column wall 60 (dashed lines 74B to 74E). The bowing in the dashed lines is exaggerated to demonstrate the effect more clearly. Thus, the flow in the central region disposed about the column axis exits the outlet end of the column bed 62 before the flow in the outer region closer to the column wall 60.

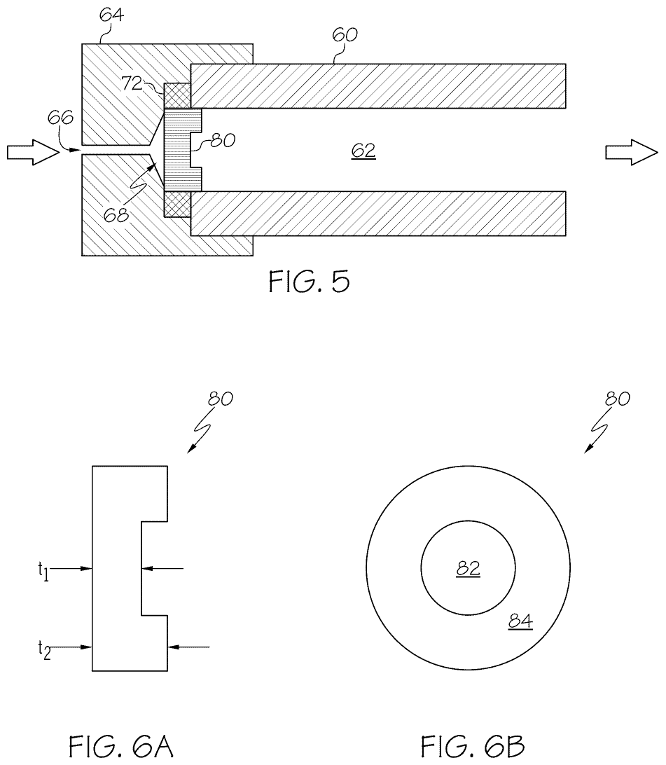

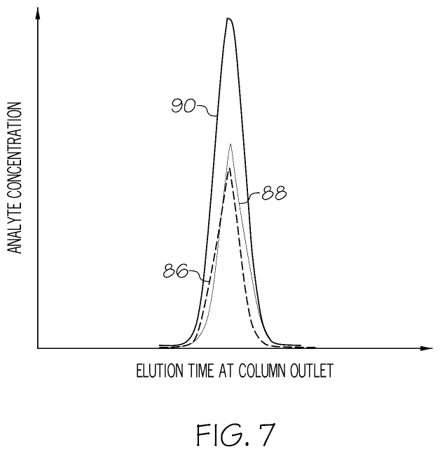

FIG. 5 is a cross-sectional side view illustration of an inlet end portion of an example of a chromatography column in accordance with the principles described herein to achieve improved chromatographic performance. The column is similar in structure to the column of FIG. 4; however, the frit 70 is effectively replaced with a frit 80 having a non-constant thickness across its diameter. FIGS. 6A and 6B are a side view illustration and end view illustration, respectively, of the frit 80. A central region 82 has a thickness t₁ that is less than a thickness t₂ of an annular outer region 84. Because the column bed 62 has a greater flow restriction than the frit 80, flow passes through the frit material faster than an equivalent thickness of the column bed. Flow in the central region 82 passes through a thinner portion of frit 80 and therefore passes through an additional length of the column bed 62 before reaching the outlet end. This extra length is determined by the difference in the two thicknesses t₂ and t₁. The flow at the outlet end of the frit 80 (as defined as the distance t₂ downstream from the inlet face) in the outer region 84 is advanced at the inlet end of the column bed 62 relative to the flow in the central region 82. For a constant porosity frit material, the thickness difference t₂−t₁ is selected (predetermined) to achieve a flow advance in the outer region that is counteracted by the advance of the flow in the central region 82 relative to the outer region 84 through the length of the column bed 62 due to the radial variation in the linear chromatographic velocity. Stated otherwise, the flow is intentionally distorted by the frit 80 in a manner to at least partially compensate for the radial flow distortion subsequently imparted along the length of the column bed 62. As a result, the flow through the outer region 84 of the column bed 62 exits the column at substantially the same time as the flow through the central region 82. FIG. 7 shows how a chromatographic peak 86 based the flow through the central region 82 will overlap in time with a chromatographic peak 88 based on the flow through the outer region 84 to yield a better resolved chromatographic peak 90.

The frit 80 may be fabricated using a pressing or sintering process. Alternatively, the frit 80 may be fabricated using metal three-dimensional (3D) printing processes or constructed from two or more pieces of frit material secured together. Examples of materials that may be used to fabricate the frit 80 include stainless steel, titanium, PEEK and glass.

In another alternative, the frit may be a disk of constant thickness and the porosity of the frit may vary in the radial direction. For example, the outer region 84 of the frit may be more porous (and less restrictive to flow) than the central region 82 to advance the flow through the outer region 84 relative to the central region 82.

It should be recognized that the radial variation in linear chromatographic velocity is not binary in nature. Consequently, the chromatographic column depicted in FIG. 5 may not fully compensate for the distortion due to the wall effect.

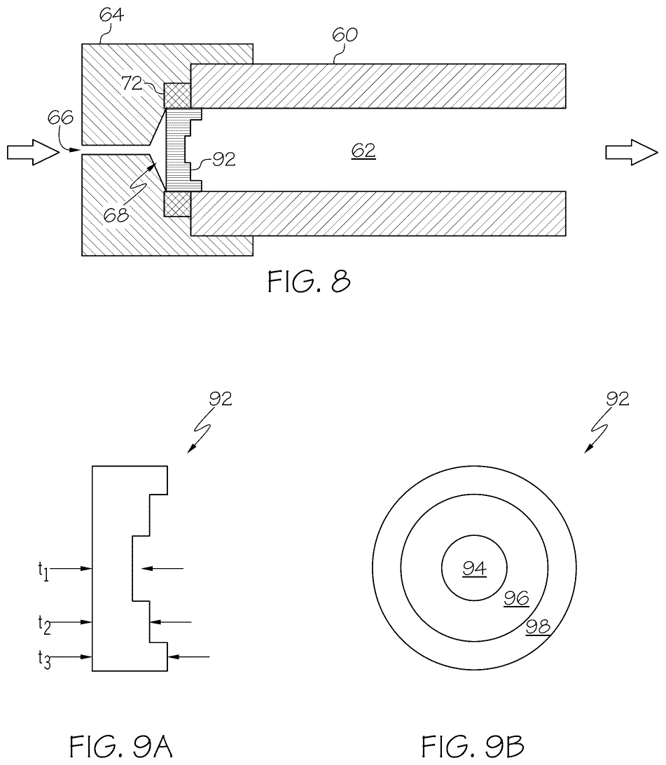

FIG. 8 is a cross-sectional side view depiction of an inlet end portion of a chromatographic column in accordance with another example that includes a frit 92 having an additional radial zone. A side view and an end view illustration of the frit 92 are shown in FIGS. 9A and 9B, respectively. The frit 92 includes three zones: a central region 94 of thickness t₁, an intermediate annular region 96 of thickness t₂ and an outer annular region 98 of thickness t₃. Use of an additional region enables three thickness to better match the continuous radial variation in linear chromatographic velocity imparted by the column bed 62.

It will be appreciated that greater numbers of regions of different thicknesses may be used. In alternative examples, the frit may be formed as a disk of constant thickness and include radial zones each having a different porosity. For example, each zone of increased radial distance from the column axis can have an increased porosity.

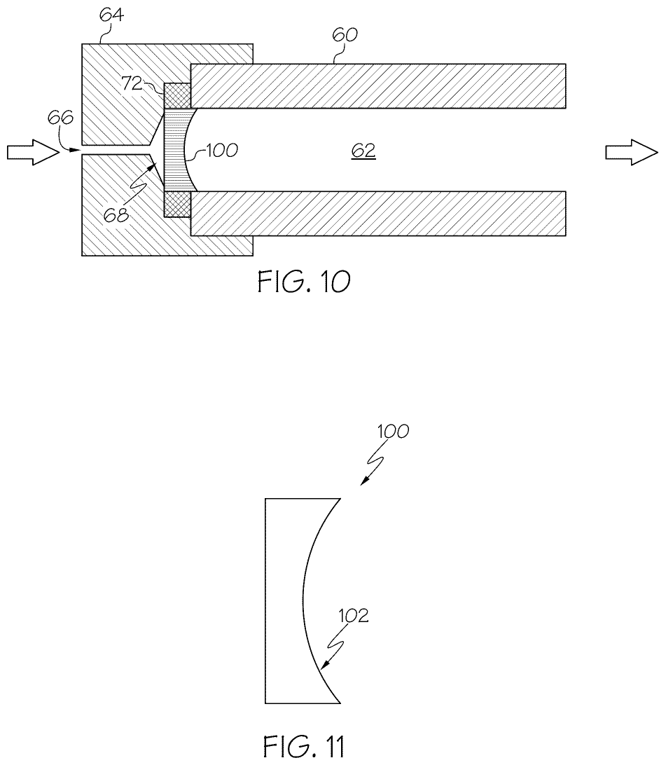

FIG. 10 shows yet another example of an inlet end portion of a chromatographic column. In this example, a frit 100 includes a continuous variation in its thickness as defined by a curved outlet surface 102, as shown in FIG. 11, to better address the continuous nature of the radial variation in chromatographic velocity. The radius of curvature or aspheric curvature of the surface may be defined to substantially compensate for the distortion imparted by the column bed. It will be recognized that a frit in the form of a flat disk having a continuous radial variation in porosity can be used in an alternative to the illustrated embodiment.

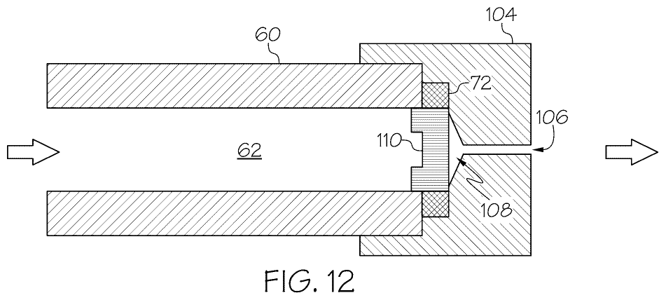

In the examples described above, the frit at the inlet end of the chromatographic column is formed to distort the flow at the column inlet to at least partially compensate for downstream flow distortion by the column bed. It will be recognized that a frit at the column outlet may instead be used to compensate for the column bed distortion. FIG. 12 shows an example of the outlet end of a chromatographic column in which the device includes an end nut 104, with an outlet channel 106, a collector 108 and a frit 110 that is similar to the two zone frit 80 of FIG. 5. In this configuration, at least a partially compensating distortion is imparted by the frit 80 to the distorted flow exiting the outlet end of the column bed 62. It will be appreciated that the frit 80 can take on other forms such as those described above. For example, a frit having any number of radial zones of different thicknesses or porosities may be used.

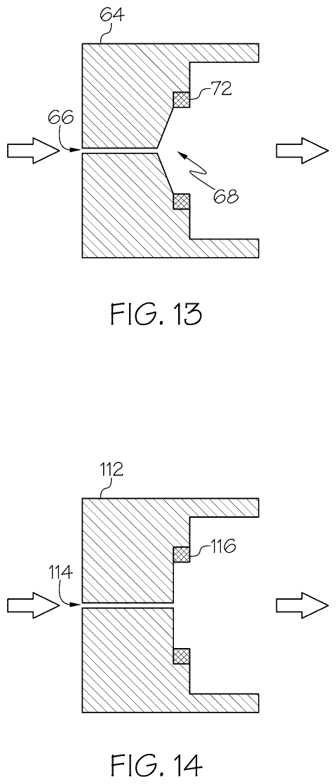

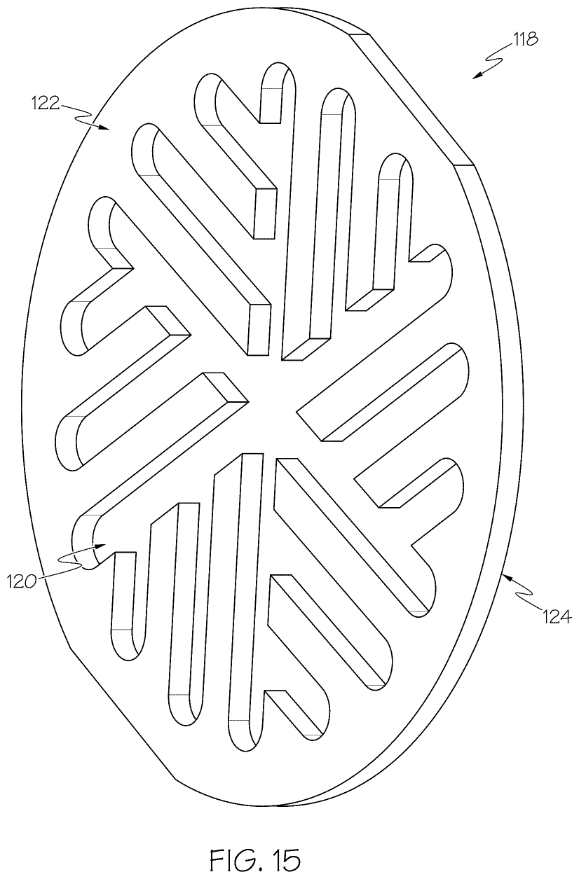

FIG. 13 shows a simplified cross-sectional view of the inlet end nut 64 used in various examples described above. In alternative examples, an end nut 112 as shown in FIG. 14 can be used. The end nut 112 does not include a conical opening for a distributor. Instead, a distributor in the form of a flat plate positioned inside the end nut 112 distributes a flow received at the inlet 114 across the front face of the sorbent bed. A gasket 116 is provided at the base of the recessed region at the outlet side of the end nut 112. FIG. 15 shows an example of a distributor plate 118 that may be used with the end nut 112. The distributor plate 118 includes an opening 120 through the plate that passes the received flow. The opening 120 includes radially-extending portions from the center of the plate with smaller opening portions extending from the radial portions. A flow of liquid received at the front side 122 of the plate 118 passes through the opening 120 and exits at the back side 124. The exiting flow is received at the inlet face of a frit (not shown) having a variation in the porosity in a radial direction and/or a variation in the thickness in the radial direction. Advantageously, the flow is substantially uniform across the inlet face of the frit. It should be recognized that, in alternative distributor plates, more than one opening may be present and the configuration of the various portions of an opening may be arranged differently while still providing a substantially uniform flow to the frit.

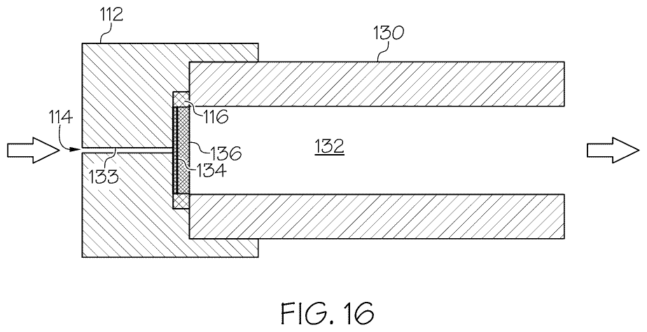

FIG. 16 is a simplified cross-sectional side view illustration of an inlet end portion of an example of a chromatography column utilizing the end nut 112 of FIG. 14. In contrast to the chromatography column illustrated in FIG. 5 which uses a conical opening 68 as a distributor, a distributor plate 134 positioned at the outlet side of the channel 133 which extends from the inlet port 114 through the end nut 112. The distributor plate 134 is used to substantially uniformly distribute the flow received at the inlet port 114 across the inlet face of the frit 136 and through to the inlet end of the column bed 132. The frit 136 is shown as a disk which has a variation in porosity in the radial direction; however, in alternative embodiments the frit 136 may be a flat disk having a radial variation in thickness.

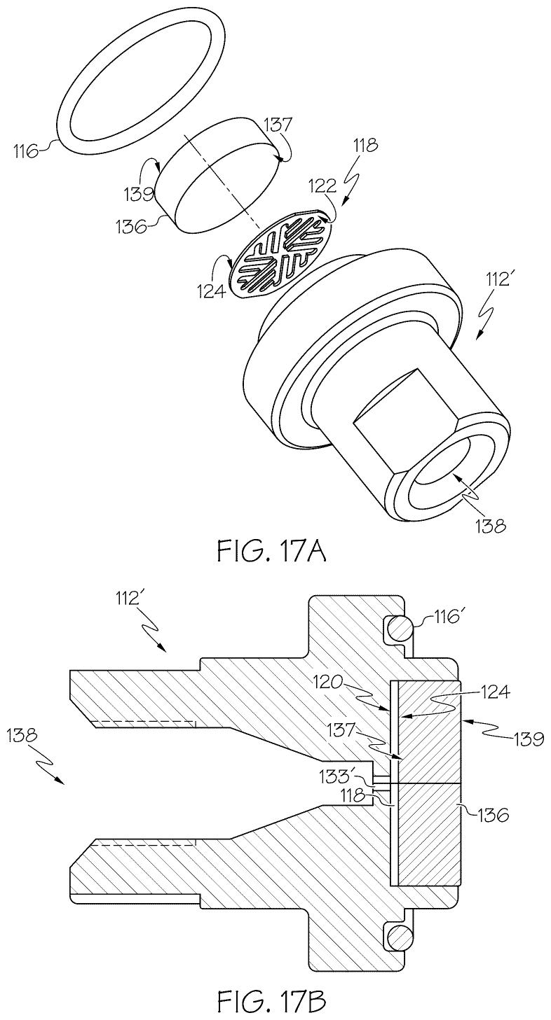

FIG. 17A and FIG. 17B show a detailed exploded view and cross-sectional side view, respectively, of one example of the end nut 112 shown in FIG. 16. In this example, the end nut 112′ is configured at an inlet end 138 for coupling to tubing or other form of conduit that provides the flow. The end nut 112′ includes a channel 133′ that extends from the inlet coupling to an outlet side which abuts an inlet side 122 of the distributor plate 118. As illustrated, the distributor plate 118 is the same as that shown in FIG. 15; however, it will be recognized that distributor plates configured with one or more different openings may be used. The inlet face 137 of the frit 136 abuts the outlet side 124 of the distributor plate 118 and the outlet face 139 abuts the inlet end of the column bed (not shown). The column wall 130 is sealed against the end nut 112′ using the gasket 116.

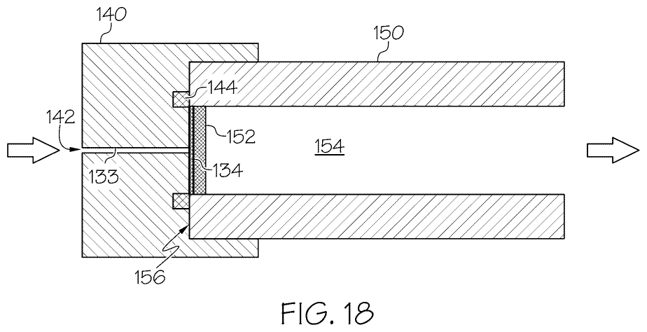

FIG. 18 is a simplified cross-sectional side view illustration of an inlet end portion of another example of a chromatography column. In this example, a frit 152 is immobilized inside the column wall 150 at the inlet end and is positioned against the inlet end of the column bed 154. A second frit (not shown) is immobilized inside the column wall at the outlet end. As described in U.S. Pat. No. 9,983,178, which is incorporated herein by reference, the frits may be adhered to the column bed 154 by using a sintering process or other chemical or physical immobilization technique. Thus, the frit 152 shown in the illustration is independent of the end nut 140. The distributor plate 134 is disposed between the end nut 140 and the frit 152 at the end 158 of the column wall 150. It will be recognized that the outlet end of the column is similarly configured; however, the frits may not be identical although at least one of the frits has a variation in porosity in the radial direction and/or a variation in thickness in the radial direction.

In some examples of end nuts described above, a conical opening at one end of the end nut is used as either a distributor or a collector and no distributor plate or collector plate is used. In some alternatives to these examples, a distributor plate or collector plate is used in combination with an end nut having a conical opening to achieve the desired uniform distribution of flow through the frit.

In the examples provided above, chromatography columns are configured such that one of the frits has a radial variation in porosity or thickness. In an alternative configuration, each of the two end nuts may be configured with a radial variation in porosity or thickness. In this way, each frit contributes a distortion such that the two distortions substantially compensate for the radial variation in chromatographic velocity imparted by the column bed.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A frit for a chromatography column, the frit comprising a disk having a porosity, a radius and a thickness, the disk having at least one of a variation in the porosity in a radial direction and a variation in the thickness in the radial direction, wherein a flow of a liquid received at an inlet end of the disk is advanced at an outlet end of the disk in an outer region of the disk relative to the flow of the liquid in an inner region of the disk in response to the at least one of the variation in the porosity in the radial direction and the variation in the thickness in the radial direction, wherein the frit is configured to be disposed at one end of a column bed of a liquid chromatography column and wherein the advance in the flow of the liquid in the outer region relative to the flow of the liquid in the inner region is predetermined to at least partially compensate for a radial variation in the linear velocity of the flow of the liquid through the column bed.

2. The frit of claim 1, wherein the thickness in the outer region is greater than the thickness in the inner region.

3. The frit of claim 2, wherein the disk includes a central cross-section having a thickness and at least one annular cross-section having a thickness that is greater than the thickness of the central cross-section.

4. The frit of claim 3, wherein the disk includes a plurality of annular cross-sections each having a different thickness.

5. The frit of claim 1, wherein the variation in the thickness in the radial direction is a continuous variation in the thickness.

6. The frit of claim 1, wherein the porosity in the outer region is greater than the porosity in the inner region.

7. The frit of claim 6, wherein the disk includes a central circular cross-section having a porosity and at least one annular cross-section having a porosity that is greater than the porosity of the central circular cross-section.

8. The frit of claim 7, wherein there is a plurality of annular cross-sections each having a different porosity.

9. The frit of claim 1, wherein the variation in the porosity in the radial direction is a continuous variation in the porosity.

10. A device for controlling flow across a diameter of a chromatography column, comprising:
an end nut configured for attachment to an inlet end or an outlet end of a column bed; and
a frit disposed in the end nut, the frit comprising a disk having a porosity, a radius and a thickness, the disk having at least one of a variation in the porosity along the radius and a variation in the thickness along the radius, wherein a flow of a liquid received at an inlet end of the disk is advanced at the outlet end of the disk in an outer region relative to a flow of the liquid in an inner region by a predetermined distance in response to the at least one of the variation in the porosity along the radius and the variation in the thickness along the radius, wherein the advance in the flow of the liquid in the outer region relative to the flow of the liquid in the inner region is predetermined to at least partially compensate for a radial variation in the linear velocity of the flow of the liquid through the column bed.

11. The device of claim 10, wherein the end nut is an inlet end nut having an inlet to receive the flow of liquid, the device further comprising a distributor disposed between the inlet end nut and the frit.

12. The device of claim 11, wherein the distributor includes a conical opening formed in the inlet end nut to distribute the flow received at an inlet port of the inlet end nut into a substantially uniform flow across an inlet face of the frit.

13. The device of claim 11, wherein the distributor includes a flat plate having at least one opening shaped to distribute the flow received at an inlet port of the inlet end nut into a substantially uniform flow across an inlet face of the frit.

14. The device of claim 10, wherein the end nut is an outlet end nut having an outlet to provide the flow of liquid, the device further comprising a collector disposed between the outlet end nut and the frit.

15. The device of claim 14, wherein the collector includes a conical opening formed in the outlet end nut to collect the flow from the column bed and provide the flow through the outlet.

16. The device of claim 14, wherein the collector includes a flat plate having at least one opening shaped to substantially uniformly collect the flow from the column bed and provide the flow through the outlet.

17. A chromatography column, comprising:
a column wall;
a column bed comprising a stationary phase material disposed inside the column wall and having an inlet end and an outlet end;
an inlet end nut secured at the inlet end of the column bed;
an outlet end nut secured at the outlet end of the column bed; and
a first frit disposed between the inlet end of the column bed and the inlet end nut and a second frit disposed between the outlet end of the column bed and the outlet end nut, at least one of the first and second frits comprising a disk having a porosity, a radius and a thickness, the disk having at least one of a variation in the porosity in the in a radial direction and a variation in the thickness in the radial direction, wherein a flow of a liquid received at an inlet end of the disk is advanced at an outlet end of the disk in an outer region of the disk relative to the flow of the liquid in an inner region of the disk in response to the at least one of the variation in the porosity in the radial direction and the variation in the thickness in the radial direction.

18. The chromatography column of claim 17, wherein the advance in the flow of the liquid in the outer region relative to the flow of the liquid in the inner region is predetermined to at least partially compensate for a radial variation in the flow of the liquid through the column bed.

19. The chromatography column of claim 17, wherein the inlet end nut includes an inlet port to receive the flow of the liquid and a distributor to provide the received flow of the liquid through the first frit to the inlet end of the column bed.

20. The chromatography column of claim 17, wherein the outlet end nut includes a collector to receive the flow of the liquid from the outlet end of the column bed after passing through the second frit and an outlet port to provide the received flow of the liquid.

21. The chromatography column of claim 17, wherein the column wall is coated with at least one material selected from the group consisting of stainless steel, titanium, polyether ether ketone and glass.

22. The chromatography column of claim 17, wherein the first and second frits are outside the column wall.

23. The chromatography column of claim 17, wherein the first and second frits are immobilized inside the column wall at the inlet and outlet ends of the column bed, respectively.
